(19) United States
(12) Patent Application Publication
(10) Pub. No.: US 2018/0323744 A1
(43) Pub. Date: Nov. 8, 2018

(54) COUPLING ASSEMBLY AND METHOD OF COUPLING SOLAR MODULES TOGETHER IN AN ARRAY

(71) Applicant: RBI Solar, Inc., Cincinnati, OH (US)

(72) Inventor: John Hudson, Mableton, GA (US)

(21) Appl. No.: 15/586,852

(22) Filed: May 4, 2017

(51) Int. Cl. H02S 30/10; H02S 20/23

(52) U.S. Cl. CPC H02S 30/10; H02S 20/23

(57) ABSTRACT

A coupling assembly for coupling solar photovoltaic modules together in an array includes a base portion including a base surface for operatively engaging a bottom surface of at least one of the solar photovoltaic modules. The coupling assembly also includes a cap portion including a clamping surface located opposite the base surface for operatively engaging a top surface of at least one of the solar photovoltaic modules. The coupling assembly further includes a spacer slidably mounted to one of the base portion or the cap portion and having first and second abutment sides each configured to operatively engage a side surface of at least one of the solar photovoltaic modules. The base surface and the clamping surface are moveable relative to each other such that movement of the clamping surface toward the base surface provides a clamping action on at least one of the solar photovoltaic modules positioned therebetween.

### FIELD OF THE INVENTION

The present application relates generally to solar array coupling assemblies and methods. More specifically, the present application describes mechanisms and methods for coupling a plurality of solar photovoltaic modules together in an array.

### BACKGROUND OF THE INVENTION

Solar arrays are an integral part of photovoltaic (PV) or solar power systems and are primarily used to absorb sunlight which is subsequently converted by the system into electricity. In many cases, a solar array is mounted to a roof of a building, such as a residence or business, to supply electricity thereto. A solar array typically consists of one or more solar PV panels or modules mechanically and electrically coupled together. While there are many different designs and configurations of modules, one exemplary module design includes a PV laminate comprising any number of solar cells (e.g., wired in series) and a rear backsheet, a cover (e.g., a soft and flexible tempered glass) positioned over the top of the PV laminate, and a frame (e.g., a metal such as aluminum) extending around the outer edge of the PV laminate and/or cover. Modules are typically rectangular in shape, and thus have four sides.

In order to install a solar array, coupling assemblies are manually clamped over the frames of adjacent modules to couple the modules together. To this end, each coupling assembly may include a base portion having a first base surface for supporting bottom surfaces of the modules, and may further include a cap portion having a first clamping surface located opposite the base surface for engaging top surfaces of the modules. The first base surface may be positioned underneath modules on the same side of the coupling assembly to operatively engage bottom surfaces thereof (e.g., the bottom surfaces of the respective frames), and the first clamping surface is brought toward the base surface to provide a clamping action on the modules to couple the modules together. The base portion may also have a second base surface on a side of the base portion opposite the first base surface, and the cap portion may also have a second clamping surface on a side of the cap portion opposite the first clamping surface, for coupling together modules on opposite sides of the coupling assembly. Thus, a single coupling assembly may accommodate up to four modules.

To sufficiently clamp the frames (e.g., to avoid a module from becoming dislodged) and provide proper weight distribution of the modules across the coupling assemblies, each module must occupy a certain minimum amount of space on the corresponding base and clamping surfaces. In this regard, a positioning requirement may be provided for each coupling assembly, such as a predetermined acceptable range for placement of the module frames relative to the coupling assembly. If a coupling assembly is improperly clamped to a module frame such that the module frame sits outside of the acceptable range, the structural integrity of the solar array may be compromised. Therefore, it is very important that installers of solar arrays comply with the positioning requirement. However, compliance can be difficult to achieve. For example, when a pair of modules are on the same side of the coupling assembly, one of the modules may take up an excessive share of the base and clamping surfaces, leaving an insufficient share of those surfaces for the other module. In many cases, this defect may go unnoticed and/or unresolved, resulting in a poorly constructed solar array subject to damage and/or failure.

Some existing coupling assemblies include scribed alignment markings to indicate to an installer the outer bounds of the required module frame positioning. Examples of such coupling assemblies are sold under the trademarks EcoFasten Solar® and Quick Mount PV®. However, the alignment markings require the installer to visually assess the positioning of the module frame relative to the alignment markings. This process can be frustrating, time consuming, and prone to mistakes. Consequently, in many cases the alignment markings are insufficient to avoid improper placement of modules.

Thus, it would be desirable to provide systems and methods to provide improved coupling of solar modules in an array in order to ensure proper positioning of the modules, thereby to improve the integrity and ease of assembly of solar arrays.

### SUMMARY OF THE INVENTION

In one embodiment, a coupling assembly for coupling a plurality of solar photovoltaic modules together in an array includes a base portion including at least one base surface for operatively engaging a bottom surface of at least one of the solar photovoltaic modules. The coupling assembly also includes a cap portion including at least one clamping surface located opposite the at least one base surface for operatively engaging a top surface of at least one of the solar photovoltaic modules. At least one of the base surface or the clamping surface extends between first and second ends. The coupling assembly further includes a spacer slidably mounted to one of the base portion or the cap portion and having first and second abutment sides each configured to operatively engage a side surface of at least one of the solar photovoltaic modules, the first and second abutment sides facing the first and second ends, respectively. The at least one base surface and the at least one clamping surface are moveable relative to each other such that movement of the at least one clamping surface toward the at least one base surface provides a clamping action on at least one of the solar photovoltaic modules positioned therebetween.

In another embodiment, a method of coupling a plurality of solar photovoltaic modules together in an array with a coupling assembly including a base portion having at least one base surface, the coupling assembly further including a cap portion having at least one clamping surface, and a spacer variably positionable along one of the base portion or the cap portion and having first and second abutment sides, is provided. The method includes positioning the base portion adjacent a first solar photovoltaic module such that the at least one base surface and the first abutment side operatively engage a first bottom surface and a first side surface of the first solar photovoltaic module, respectively. The method also includes positioning the base portion adjacent a second solar photovoltaic module such that the at least one base surface and the second abutment side operatively engage a second bottom surface and a second side surface of the second solar photovoltaic module, respectively. The method further includes positioning the cap portion over the base portion such that the at least one clamping surface operatively engages first and second top surfaces of the first and second solar photovoltaic modules, respectively. And the method includes moving the at least one clamping surface toward the at least one base surface to provide a clamping action on the first and second solar photovoltaic modules.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrate one or more embodiments of the invention and, together with the general description given above and the detailed description given below, serve to explain the one or more embodiments of the invention.

FIG. 1 is a perspective view of a solar array mounted to a roof and including exemplary coupling assemblies in accordance with one embodiment of the invention.

FIG. 2 is a perspective view of a coupling assembly of FIG. 1.

FIG. 2A is a front cross sectional view of the coupling assembly of FIG. 2, taken along section line 2A-2A in FIG. 2, showing the clamping surfaces of the cap portion moved toward the corresponding base surfaces of the base portion.

FIG. 3 is an exploded perspective view of the coupling assembly of FIG. 2.

FIGS. 4A-4E are side elevation views showing a series of steps for installing the coupling assembly of FIG. 2 over a plurality of solar modules.

FIG. 4F is a front cross sectional view of the arrangement of FIG. 4E, taken along section line 4F-4F in FIG. 4E.

FIG. 5 is a perspective view of another second coupling assembly of FIG. 1, mounted on a support assembly.

FIG. 6 is an exploded perspective view of the coupling assembly and support assembly of FIG. 5.

FIG. 7 is a side elevation view of the coupling assembly and support assembly of FIG. 5, mounted on a roof.

### DETAILED DESCRIPTION OF THE INVENTION

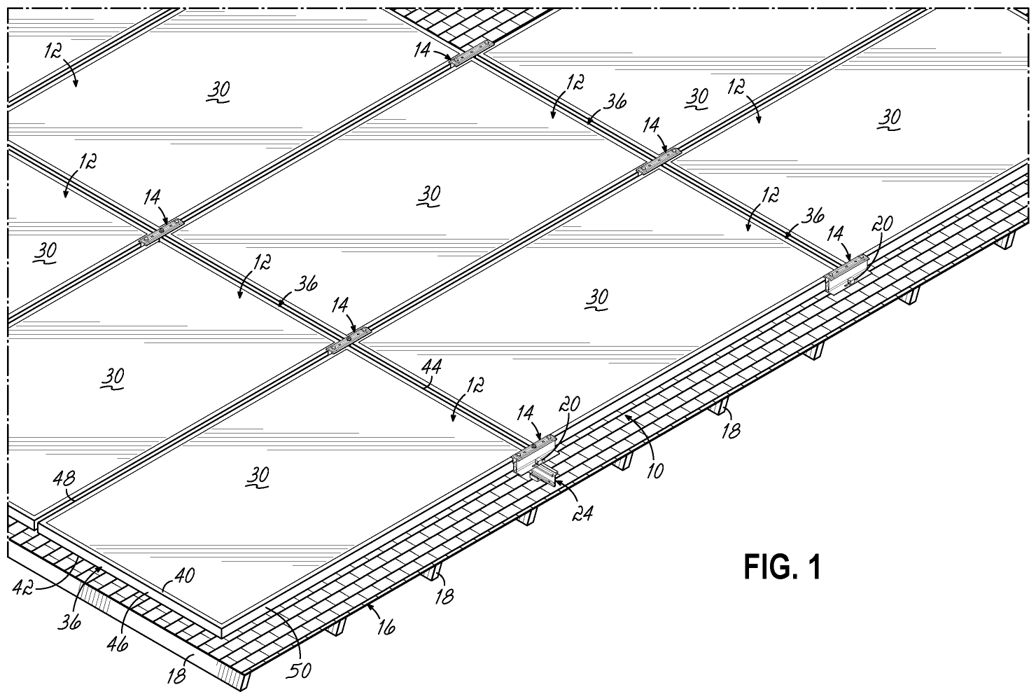

With reference to FIG. 1, a solar array 10 including a plurality of solar PV modules 12 coupled together via coupling assemblies 14 and mounted to a roof 16 having support beams 18 is shown in accordance with one embodiment. As set forth in further detail below, the coupling assemblies 14 are clamped over adjacent modules 12 to form a secure and tight connection between the modules 12. To this end, the coupling assemblies 14 each include a variably positionable (e.g., slidable) spacer 20 to ensure proper positioning of the modules 12 relative to the coupling assemblies 14 and thereby provide improved integrity and ease of assembly to the solar array 10. As shown, at least one coupling assembly 14 may be mounted on a support assembly 24 coupled to the roof 16 and at least one coupling assembly 14 may float (e.g., is suspended) above the roof 16. The features of each coupling assembly 14 are set forth in further detail below to clarify each of these functional advantages and other benefits provided in this disclosure.

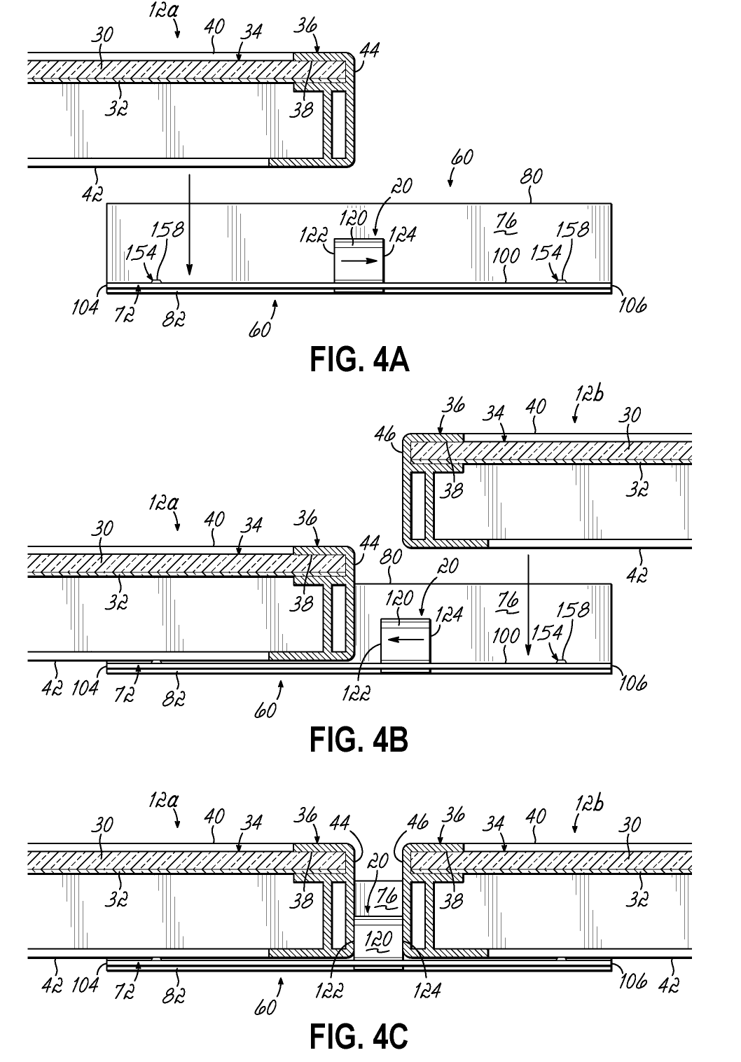

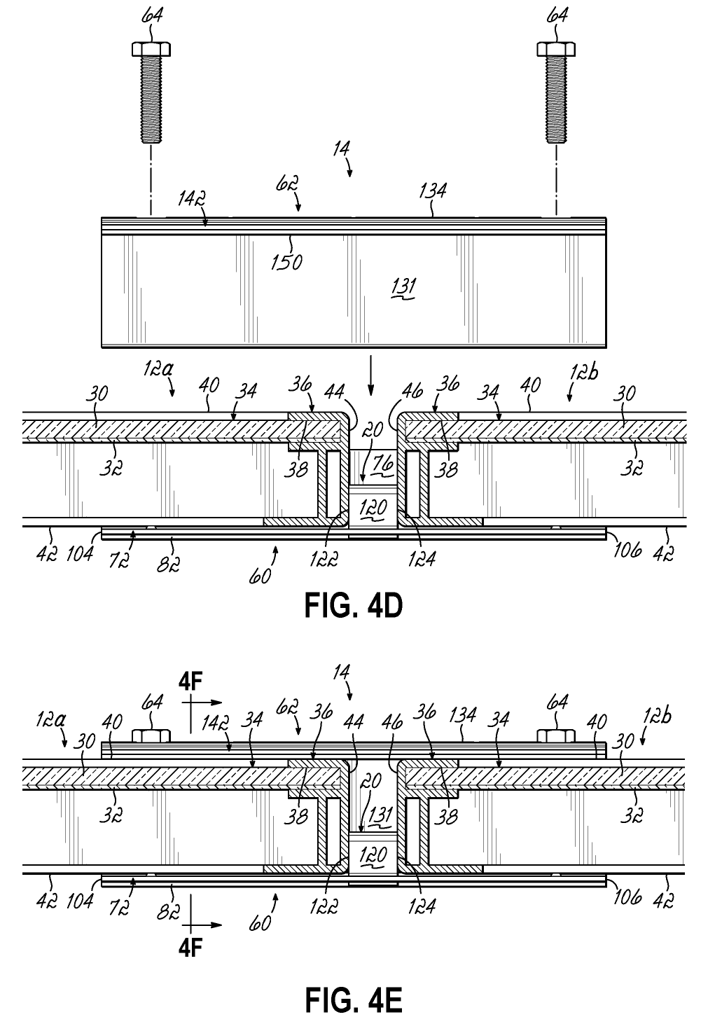

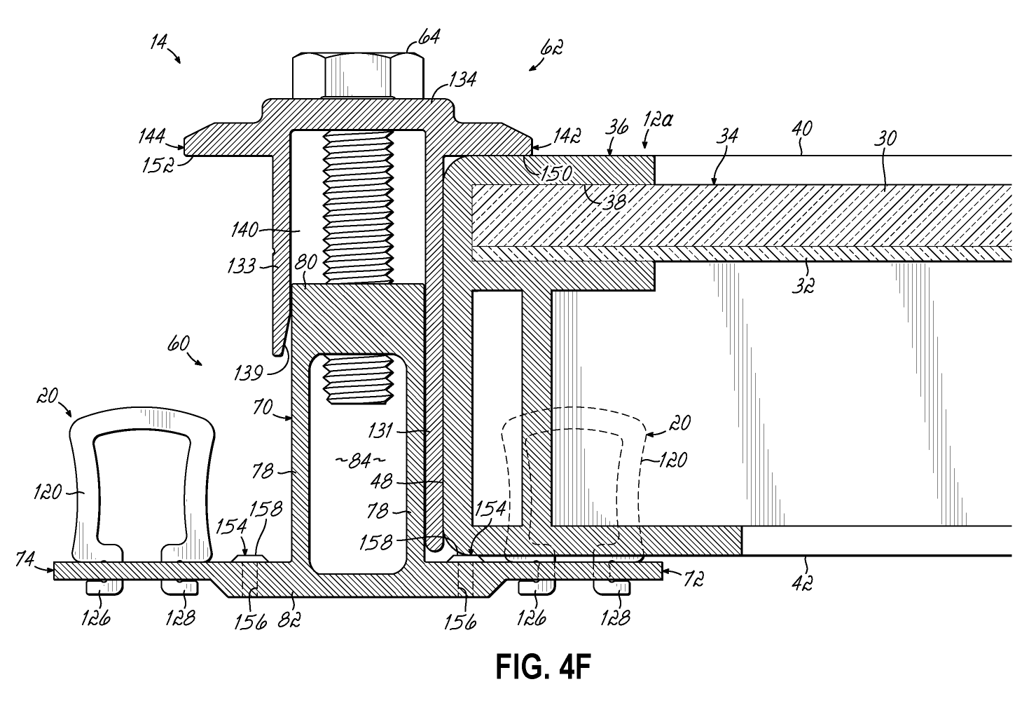

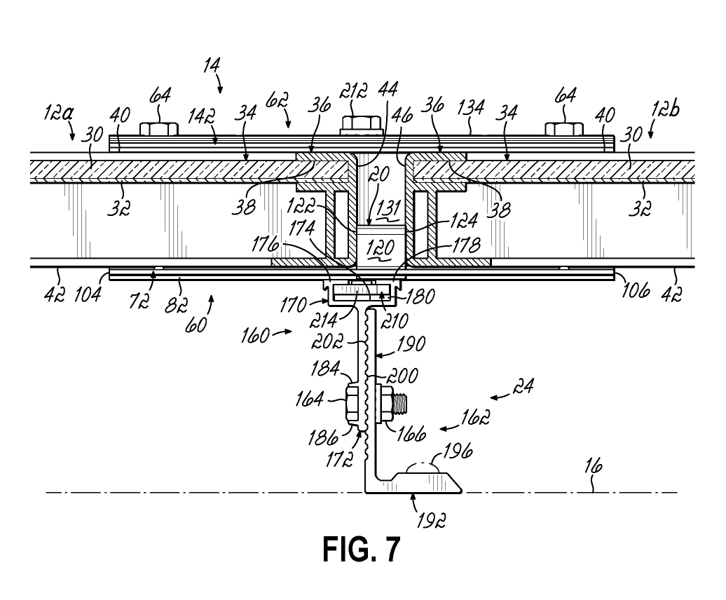

Each of the modules 12 of the solar array 10 includes a cover 30 positioned over a PV laminate 32 (FIGS. 4A-4F and 7) to form a stack 34, and a frame 36 extending around the outer edge of the stack 34. While not shown in great detail, the PV laminate 32 may include a number of solar cells positioned on a backsheet. In the embodiment shown, each frame 36 includes at least one generally C-shaped channel 38 (FIGS. 4A-4F and 7) for retaining the stack 34 in a fixed position relative to the frame 36. Each frame 36 is generally rectangular in shape, and includes a top surface 40, a bottom surface 42, and first, second, third, and fourth side surfaces 44, 46, 48, 50. It will be appreciated that the particular configuration of the modules 12 may vary from that shown and described without departing from the scope of the invention.

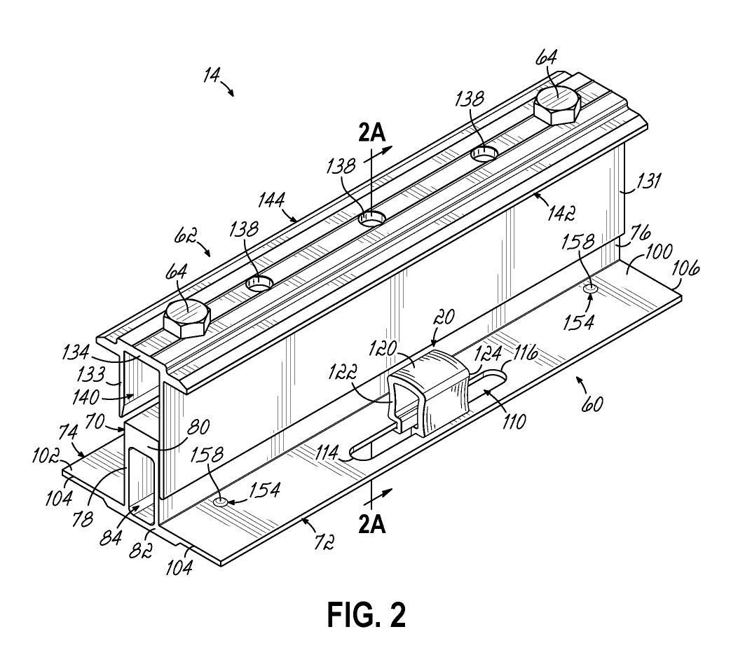

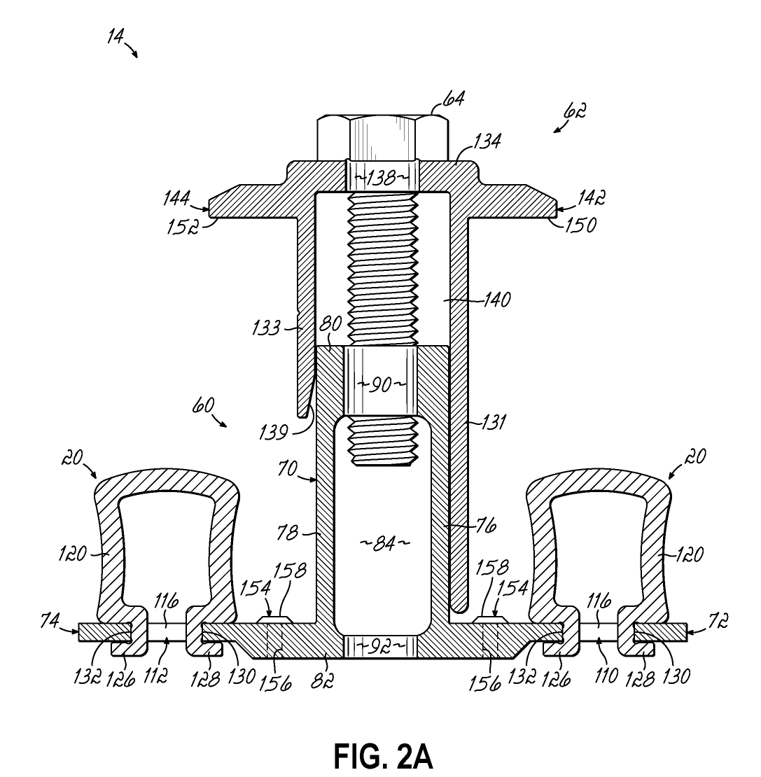

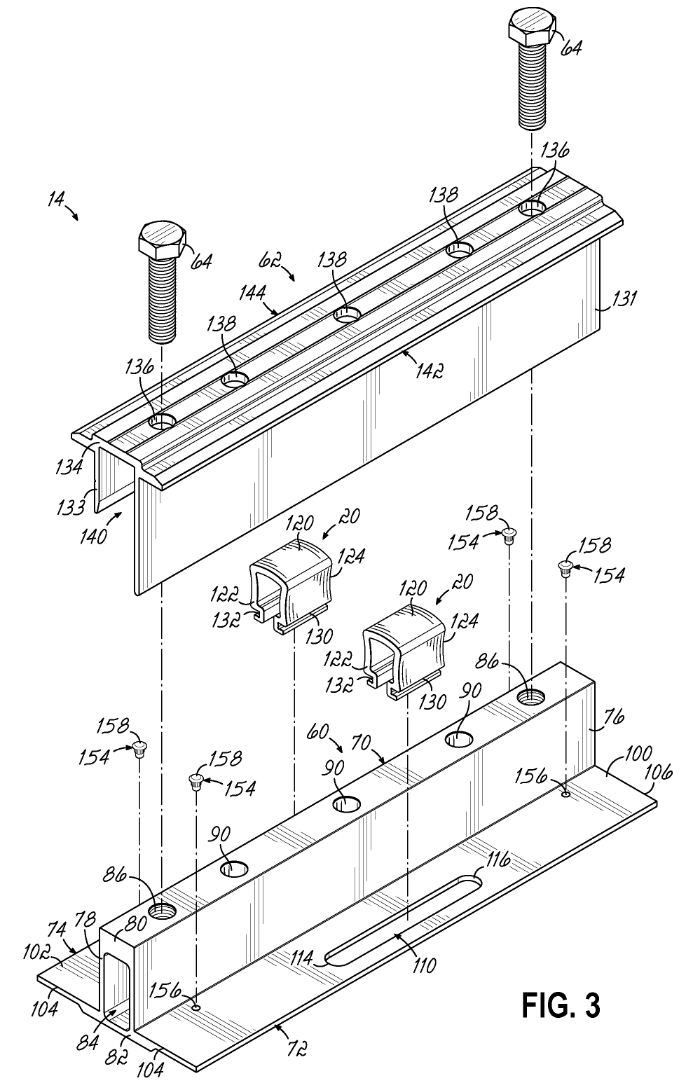

Referring now to FIGS. 2, 2A, and 3, with continuing reference to FIG. 1, each coupling assembly 14 includes a base portion 60 and a cap portion 62 coupled together by fasteners, such as bolts 64. The base portion 60 has a generally T-shaped cross section and includes an elongate central member 70 and first and second legs 72, 74 extending from opposite sides of the central member 70. In the embodiment shown, the central member 70 includes first and second upwardly extending walls 76, 78 coupled together by upper and lower lateral sections 80, 82 to define a cavity 84. A plurality of threaded holes 86 extend through the upper lateral section 80 for threadably receiving the bolts 64. A plurality of upper and lower through holes 90, 92 extend through the upper and lower lateral sections 80, 82, respectively, at corresponding locations thereof for reasons which will be discussed below.

The first and second legs 72, 74 include first and second base surfaces 100, 102, respectively, each extending between first and second ends 104, 106 thereof. As discussed in greater detail below, the base surfaces 100, 102 may operatively engage a bottom surface(s) of one or more of the modules 12, such as the bottom surface 42 of the frame 36. The first and second base surfaces 100, 102 include first and second elongate slots 110, 112, respectively, each extending between first and second termini 114, 116 for receiving at least a portion of a corresponding spacer 20. In this regard, each spacer 20 has a generally Ω-shaped cross section and includes a main body portion 120 having first and second abutment sides 122, 124 facing the first and second ends 104, 106 of the corresponding base surface 100, 102, respectively. As discussed in greater detail below, the first and second abutment sides 122, 124 may operatively engage a side surface(s) of one or more of the modules 12, such as a first, second, third, or fourth side surface 44, 46, 48, 50 of the frame 36. In one embodiment, a width of each spacer 20 between the first and second abutment sides 122, 124 may be between approximately ½ inch and approximately ¾ inch.

As shown, first and second prongs 126, 128 extend from the main body portion 120 of each spacer 20 to define first and second channels 130, 132 between the main body portion 120 and the first and second prongs 126, 128, respectively. The channels 130, 132 are each sized to receive the corresponding portions of the first and second legs 72, 74 which form the peripheries of the first and second slots 110, 112, such that each spacer 20 may be slidably mounted to the base portion 60. Each spacer 20 may be formed of a semi-flexible material, such as a polymer or aluminum, to facilitate insertion of the spacer 20 into the corresponding slot 110, 112. It will be appreciated that the particular configuration of the spacers 20 may vary from that shown and described without departing from the scope of the invention.

Sliding of each spacer 20 relative to the base portion 60 is limited between first and second positions (not shown) by the length of the corresponding slot 110, 112. In other words, the spacer 20 may be in the first position, the second position, or any position between the first and second positions. In this regard, the first and second termini 114, 116 of each slot 110, 112 establish the outer bounds for sliding the spacer 20. For example, when the spacer 20 abuts the first terminus 114, the spacer 20 may be in the first position, and when the spacer 20 abuts the second terminus 116, the spacer 20 may be in the second position. The first position is relatively proximate the first end 104 of the corresponding base surface 100, 102 and relatively distal the second end 106 of the corresponding base surface 100, 102, while the second position is relatively proximate the second end 106 of the corresponding base surface 100, 102 and relatively distal the first end 104 of the corresponding base surface 100, 102. Each slot 110, 112 may be sized such that when the corresponding spacer 20 is in the first position, the first abutment side 122 of the spacer 20 may be spaced apart from the first end 104 to define a first designated clamping zone. In addition, each slot 110, 112 may be sized such that when the corresponding spacer 20 is in the second position the second abutment side 124 of the spacer 20 may be spaced apart from the second end 106 to define a second designated clamping zone. To these ends, the first and second termini 114, 116 may be spaced apart from the first and second ends 104, 106, respectively, by distances that correspond to the minimum amount of space desired on the coupling assembly 14 to adequately clamp the module 12. For example, such distances may be equal to or greater than a minimum desired length of engagement between the base surface 100, 102 and the module 12. In this manner, the spacer 20 may ensure adequate space along the coupling assembly 14 for each of a pair of modules 12 positioned on the same side of the coupling assembly 14. In particular, the spacer 20 may prevent either of such modules 12 from encroaching upon the designated clamping zone for the other module 12, while still allowing for some adjustability. In one embodiment, the first and second distances may be the same such that both modules 12 are provided with an equally sized designated clamping zone. In addition or alternatively, the first distance may be between approximately 2 inches and approximately 3.5 inches. For example, the first distance may be approximately 2.875 inches.

As shown, each cap portion 62 has a generally π-shaped cross section and includes first and second downwardly extending walls 131, 133 coupled together by an upper lateral section 134. A plurality of through holes 136 extend through the lateral section 134 for alignment with the threaded holes 86 of the base portion 60 to receive the bolts 64 and thereby removably attach the base and cap portions 60, 62 to each other. An additional plurality of through holes 138 extend through the lateral section 134 for alignment with corresponding through holes 90, 92 of the base portion 60 for reasons which will be discussed below. In the embodiment shown, the first and second walls 131, 133 are spaced apart from each other to define a gap 140 such that the cap portion 62 may be at least partially fit over the central member 70 of the base portion 60. For example, the gap 140 may have a width approximately equal to a width of the central member 70. As shown, the second wall 133 includes a beveled end 139 to assist in fitting the cap portion 62 over the central member 70 of the base portion 60. As discussed in greater detail below, the first and second walls 131, 133 may operatively engage a side surface(s) of one or more of the modules 12, such as the first, second, third, or fourth side surface 44, 46, 48, 50 of the frame 36.

First and second arms 142, 144 extend from opposite sides of the lateral section 134 and include first and second clamping surfaces 150, 152, respectively. As shown, when the cap portion 62 is positioned over and aligned with the base portion 60 for clamping, the first and second clamping surfaces 150, 152 are located opposite the first and second base surfaces 100, 102, respectively, and the first and second walls 131, 133 of the cap portion 62 are located between the base surfaces 100, 102 and the clamping surfaces 150, 152. As discussed in greater detail below, the clamping surfaces 150, 152 may operatively engage a top surface(s) of one or more of the modules 12, such as the top surface 40 of the frame 36. In this regard, the clamping surfaces 150, 152 are movable relative to the respective base surfaces 100, 102 so as to provide a clamping action on at least one module 12 positioned therebetween. For example, advancing the bolts 64 in the corresponding threaded holes 86 of the base portion 60 moves the clamping surfaces 150, 152 toward the respective base surfaces 100, 102, such as from a first position (FIG. 2) to a second position (FIG. 2A). Thus, the first and second designated clamping zones are each sized such that the corresponding base surfaces 100, 102 and clamping surfaces 150, 152 are operable to provide a sufficient clamping action on any module(s) 12 positioned in such designated clamping zones.

In the embodiment shown, the first wall 131 of the cap portion 62 is taller than the second wall 133 of the cap portion 62, and thus may effectively limit the movement of the clamping surfaces 150, 152 toward the respective base surfaces 100, 102. While first and second base surfaces 100, 102 and first and second clamping surfaces 150, 152 are shown, in an alternative embodiment a coupling assembly may be equipped with a single base surface and a single clamping surface for coupling a pair of modules 12 on the same side of the coupling assembly.

As shown, the first and second legs 72, 74 of the base portion 60 each include at least one electrical bonding component such as a bonding pin 154 for providing a grounding path through the coupling assembly 14 from at least one of the modules 12. In this regard, each of the first and second legs 72, 74 includes at least one retention hole 156 for retaining a corresponding bonding pin 154. The bonding pins 154 each include a tip 158 configured to operatively engage a bottom surface of at least one of the modules 12, such as the bottom surface 42 of the frame 36, and may be held in place within the respective retention hole 156 via an interference fit and/or an adhesive. The tips 158 may be blunt, as shown, or may be sharp/pointed. In one embodiment, the operative engagement between the base surfaces 100, 102 and the bottom surface 42 may be achieved by the operative engagement between the bonding pins 154 and the bottom surface 42. While the bonding pins 154 are shown positioned on the base portion 60, it will be appreciated that the bonding pins 154 may be positioned on the cap portion 62. In another embodiment, an electrical bonding components in the form of at least one washer, electrical equipment bond such as a WEEB® (not shown) may be positioned within the cavity 84 of the base portion 60 adjacent the base surfaces 100, 102, and/or within the gap 140 of the cap portion 62 adjacent the clamping surfaces 150, 152. Alternatively, the electrical bonding components may be positioned elsewhere on either the base portion 60 or the cap portion 62, or may be eliminated without departing from the scope of the invention.

With reference to FIGS. 4A-4F, a method of coupling a plurality of modules 12 together with the coupling assembly 14 is provided. Initially, the base portion 60 of the coupling assembly 14 and a first module 12a are positioned proximate each other with the first base surface 100 of the base portion 60 being positioned below a bottom surface of the first module 12a such as the bottom surface 42 of the frame 36 (FIG. 4A). While the base portion 60 is shown as being detached from the cap portion 62, it will be appreciated that the base portion 60 and cap portion 62 may be attached to each other at this stage with the base surfaces 100, 102 and clamping surfaces 150, 152 spaced apart to receive the first module 12a. In any event, the base portion 60 is positioned adjacent the first module 12a such that the first base surface 100 of the base portion 60 operatively engages the bottom surface 42 of the first module 12a (FIG. 4B). As shown, this may involve sliding the spacer 20 in a direction generally away from the first module 12a. Alternatively, the spacer 20 may remain in place relative to the base portion 60, and the base portion 60 may be shifted in the direction generally away from the first module 12a. In any event, it will be appreciated that the spacer 20 physically prevents the installer from accidentally positioning the first module 12a in any portion of the second designated clamping zone while allowing the first module 12a to extend somewhat beyond the first designated clamping zone toward the second designated clamping zone. As shown, at least one of the bonding pins 154 may provide the operative engagement between the first base surface 100 and the bottom surface 42 of the first module 12a.

Once the first base surface 100 operatively engages the bottom surface 42 of the first module 12a, an installer may verify that the first module 12a is properly positioned in the first designated clamping zone by sliding the spacer 20 toward the first module 12a. In this regard, if the first abutment side 122 operatively engages a side surface of the first module 12a, such as the first side surface 44 of the frame 36, then this provides a positive indication to the installer that the first module 12a is properly positioned in the first clamping zone. Otherwise, the installer may shift the base portion 60 in a direction generally toward the first module 12a at least until such operative engagement occurs.

With the first base surface 100 operatively engaging the bottom surface 42 of the first module 12a, the base portion 60 and a second module 12b are positioned proximate each other with the first base surface 100 of the base portion 60 being positioned below a bottom surface of the second module 12b such as the bottom surface 42 of the frame 36 of the second module 12b (FIG. 4B). The base portion 60 is positioned adjacent the second module 12b such that the first base surface 100 of the base portion 60 operatively engages the bottom surface 42 of the second module 12b (FIG. 4C). As shown, this may involve sliding the spacer 20 in a direction generally away from the second module 12b and toward the first module 12a at least until the first abutment side 122 of the spacer 20 operatively engages the first side surface 44 of the first module 12a. Similar to the operative engagement between the first base surface 100 and the bottom surface 42 of the first module 12a, at least one of the bonding pins 154 may provide the operative engagement between the first base surface 100 and the bottom surface 42 of the second module 12b.

In any event, once the first base surface 100 operatively engages the bottom surface 42 of the second module 12b, operative engagement between the first abutment side 122 of the spacer 20 and the first side surface 44 of the first module 12a and between the second abutment side 124 of the spacer 20 and a side surface of the second module 12b, such as the second side surface 46 of the frame 36, provide positive indication that the first and second modules 12a, 12b are both properly positioned relative to the base portion 60 in the respective designated clamping zones. Otherwise, the installer may shift one or both of the modules 12a, 12b in directions generally toward the spacer 20 at least until both such operative engagements occur. If other adjustments of one or both of the modules 12a, 12b is required (e.g., due to spatial constraints originating at other sides of either module 12a, 12b), the installer may shift the first module 12a, spacer 20, and second module 12b together relative to the base portion 60 while maintaining these operative engagements. Thus, in any event, the width of the spacer 20 defines the spacing of the modules 12a, 12b from each other.

With the first base surface 100 operatively engaging the bottom surfaces 42 of the first and second modules 12a, 12b, and the first and second abutment sides 122, 124 operatively engaging the first and second side surfaces 44, 46, respectively, the cap portion 62 is positioned over the base portion 60 such that the first clamping surface 150 is located opposite the first base surface 100 (FIG. 4D). The first clamping surface 150 of the cap portion 62 is brought toward the first base surface 100 so that the first clamping surface 150 operatively engages top surfaces of the first and second modules 12a, 12b, such as the top surfaces 40 of the frames 36 (FIG. 4E). This may involve aligning the through holes 136 of the cap portion 62 with the corresponding threaded holes 86 of the base portion 60, extending the bolts 64 through the through holes 136, threadably engaging the bolts 64 with the threaded holes 86, and advancing the bolts 64 therethrough to move the first clamping surface 150 toward the first base surface 100 to provide a clamping action on the first and second modules 12a, 12b. It will be appreciated that at least a portion of the clamping action may be provided via the bonding pins 154. In one embodiment, the bonding pins 154, for example the tips 158, may at least partially penetrate the frames 36. In any event, the bolts 64 are tightened to form a secure and tight connection between the modules 12a, 12b and the coupling assembly 14. It will be appreciated that when the first clamping surface 150 operatively engages the top surfaces 40 of the modules 12a, 12b, the first wall 131 of the cap portion 62 is positioned between the central member 70 of the base portion 60 and side surfaces of the modules 12a, 12b, such as the third side surfaces 48 of the frames 36 of the modules 12a, 12b. In the embodiment shown, the first wall 131 of the cap portion 62 operatively engages the third side surfaces 48 of the modules 12a, 12b to maximize the occupancy of the designated clamping zones by the respective modules 12a, 12b (FIG. 4F). For example, when the cap portion 62 is positioned over the base portion 60, the installer may push one or both modules 12a, 12b against the first wall 131 prior to tightening the bolts 64.

In the embodiment shown in FIGS. 4A-4F, only first and second modules 12a, 12b are coupled together via the coupling assembly 14. However, third and/or fourth modules (not shown) may also be coupled together with the first and second modules 12a, 12b via the coupling assembly 14. In particular, third and/or fourth modules may be positioned between and clamped by the second base surface 102 and second clamping surface 152 in a process substantially similar to that described with respect to the first and second modules 12a, 12b. Thus, the specific steps are not repeated for the sake of brevity. Alternatively, the first and second modules 12a, 12b may be positioned on opposite sides of the coupling assembly 14, such that the first module 12a is clamped by the first base surface 100 and first clamping surface 150 and the second module 12b is clamped by the second base surface 102 and second clamping surface 152.

In some cases, such as where only two or three modules 12 are coupled together via the coupling assembly 14, the extended length of the first wall 131 of the cap portion 62 may inhibit undesirable bending of the cap portion 62 toward either side thereof as the bolts 64 are advanced through the respective threaded holes 86, which could otherwise result in failure of either clamping surface 150, 152 to operatively engage the top surface(s) 40 of the corresponding module(s) 12. In particular, the distal end of the first wall 131 may abut the first base surface 100 of the base portion 60 and thereby limit the advancement of the bolts 64. For example, the first wall 131 may have a height that is equal to or slightly less than a thickness of the one or more corresponding modules 12. Thus, as the bolts 64 are tightened, the first wall 131 may eventually “bottom out” and prevent an installer from overtightening the bolts 64. In another embodiment, the first and second walls 131, 133 of the cap portion 62 may be of substantially the same height.

It will also be appreciated that the order of steps may vary from that described with respect to the illustrated embodiment. For example, the cap portion 62 may be used to partially clamp one or more modules 12 prior to introducing additional modules 12. Once the desired number of modules 12 have been properly positioned, the bolts 64 may then be tightened to fully clamp the modules 12. In addition or alternatively, the modules 12 may be positioned adjacent each other prior to introducing the components of the coupling assembly 14.

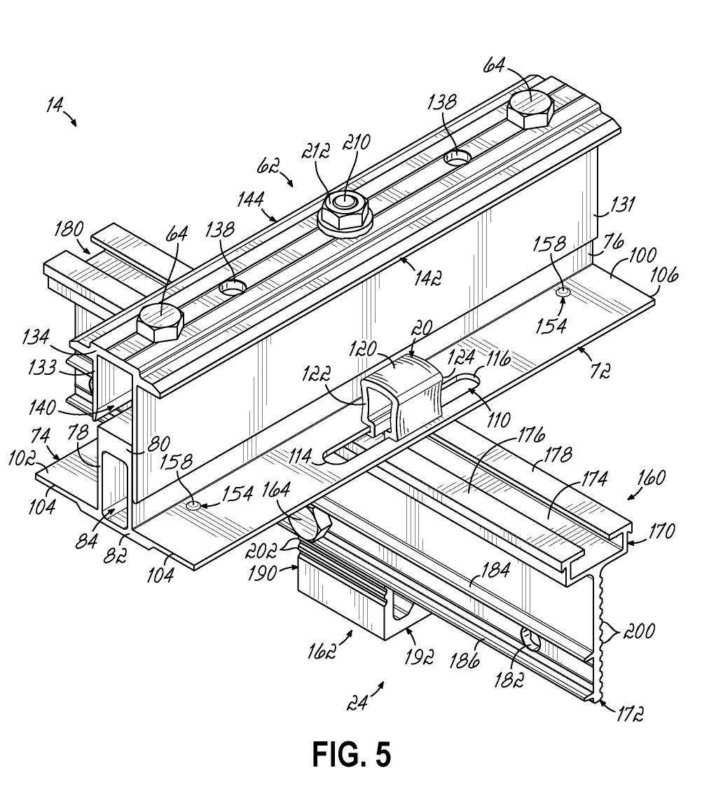

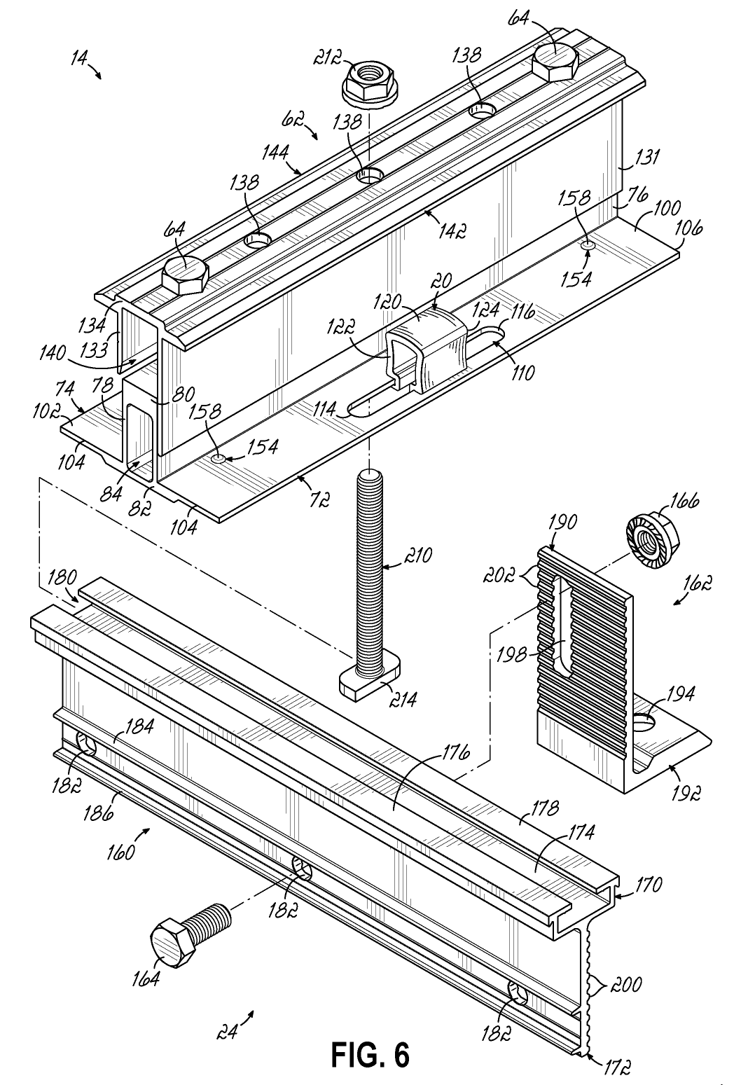

With reference now to FIGS. 5-7, in another embodiment the coupling assembly 14 is adapted for mounting on a support assembly 24, which may be operatively coupled to a working surface such as the roof 16 of a building (FIG. 1). As shown, the support assembly 24 includes a support portion 160 and at least one bracket portion 162 coupled together by at least one fastener, such as a bolt 164 and a corresponding lock nut 166. The support portion 160 has a generally T-shaped cross section and includes an elongate track 170 and a wall 172 extending downwardly therefrom. In the embodiment shown, the track 170 includes a base surface 174 and first and second generally L-shaped arms 176, 178 defining a channel 180 for reasons which will be discussed below. At least one through hole 182 extends through the wall 172 for receiving the bolt 164. As shown, upper and lower ridges 184, 186 are provided adjacent the at least one through hole 182 to prevent the head of the bolt 164 from rotating in the through hole 182, such as during assembly of the support assembly 24.

In the embodiment shown, the bracket portion 162 has a generally L-shaped cross section and includes a leg 190 and a foot 192 arranged generally perpendicular to each other. A hole 194 is provided in the foot 192 for receiving a fastener, such as a bolt 196, to operatively couple the bracket portion 162 to a working surface such as the roof 16. The leg 190 includes an aperture, such as a vertical slot 198, for receiving the bolt 196. In the embodiment shown, the vertical slot 198 allows the height of the support portion 160 relative to the bracket portion 162 to be selectively adjusted. In this regard, the wall 172 of the support portion 160 and the leg 190 include complementary serrated surfaces 200, 202. The serrated surfaces 200, 202 engage each other when the support portion 160 and bracket portion 162 are coupled together to assist in securely fixing the support portion 160 and bracket portion 162 relative to each other and to prevent the support portion 160 from sliding downwardly.

As shown, the coupling assembly 14 and support assembly 24 may be coupled together by a fastener, such as an elongate bolt 210 and a corresponding lock nut 212. The elongate bolt 210 includes a generally rectangular-shaped head 214 such that the elongate bolt 210 has a generally T-shaped cross section. The head 214 of the elongate bolt 210 is slidably received by the channel 180 of the support portion 160. The coupling assembly 14 is positioned over the support assembly 24 such that the elongate bolt 210 extends through a through hole 92 of the base portion 60, the corresponding through hole 90 of the base portion, and the corresponding through hole 138 of the cap portion 62. In the embodiment shown, the pluralities of through holes 90, 92, 138 provide three mounting locations for the coupling assembly 14 on the support assembly 24, although more or less through holes may provide more or less mounting locations. In any event, the lock nut 212 is threadably received over the elongate bolt 210 to mount the coupling assembly 14 on the support assembly 24. The head 214 of the elongate bolt 210 may be slid along the channel 180 to adjust the position of the coupling assembly 14 and support assembly 24 relative to each other. In addition or alternatively, the coupling assembly 14 may be pivoted about the elongate bolt 210 to adjust the orientation of the coupling assembly 14 and support assembly 24 relative to each other. To these ends, the L-shaped arms 176, 178 of the channel 180 may prevent the head 214 of the bolt 210 from rotating in the channel 180, such as during mounting of the coupling assembly 14 on the support assembly 24 to allow the lock nut 212 to be tightened when the coupling assembly 14 is in a desired position. In any event, it will be appreciated that the coupling assembly 14 may be mounted on the support assembly 24 before, during, or after clamping the coupling assembly 14 over the corresponding modules 12. For example, the base portion 60 of the coupling assembly 14 may be loosely mounted on the support portion 160 of the support assembly 24 prior to positioning the base portion 60 adjacent the corresponding modules 12.

Thus, referring again to FIG. 1, each coupling assembly 14 may be floated over the roof 16 (e.g., without a support assembly 24), or may be mounted on a support assembly 24 coupled to the roof 16. For example, coupling assemblies 14 positioned at or proximate any of the support beams 18 of the roof 16 may each be mounted on a support assembly 24 coupled to the roof 16, while coupling assemblies 14 spaced apart from the support beams 18 may be floated over the roof 16.

While the spacer 20 has been shown and described as being slidably mounted to the base portion 60, various other ways of configuring a spacer to be variably positionable with respect to a coupling assembly may be utilized to provide a spacer which may be moved relative to the coupling assembly according to the required positioning and/or spacing of the modules 12 described above. For example, a spacer may be slidably mounted to a cap portion of a coupling assembly in manner similar to the slidable mounting of the spacer 20 on the base portion 60. Alternatively, a spacer may be variably positionable by means other than sliding. Such variations may be utilized without departing from the scope of the invention.

While the present invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

What is claimed is:

1. A coupling assembly for coupling a plurality of solar photovoltaic modules together in an array, the coupling assembly comprising:
a base portion including at least one base surface for operatively engaging a bottom surface of at least one of the solar photovoltaic modules;
a cap portion including at least one clamping surface located opposite the at least one base surface for operatively engaging a top surface of at least one of the solar photovoltaic modules, wherein at least one of the base surface or the clamping surface extends between first and second ends; and
at least one spacer slidably mounted to one of the base portion or the cap portion and having first and second abutment sides each configured to operatively engage a side surface of at least one of the solar photovoltaic modules, the first and second abutment sides facing the first and second ends, respectively;
wherein the at least one base surface and the at least one clamping surface are moveable relative to each other such that movement of the at least one clamping surface toward the at least one base surface provides a clamping action on at least one of the solar photovoltaic modules positioned therebetween.

2. The coupling assembly of claim 1, further comprising at least one wall located between the at least one base surface and the at least one clamping surface for operatively engaging a side surface of at least one of the solar photovoltaic modules.

3. The coupling assembly of claim 1, wherein one of the base portion or the cap portion includes at least one elongate slot for receiving a portion of the at least one spacer.

4. The coupling assembly of claim 3, wherein the at least one elongate slot extends along a portion of the at least one base surface of the base portion.

5. The coupling assembly of claim 1, wherein sliding of the at least one spacer is limited between a first position proximate the first end and distal the second end, and a second position proximate the second end and distal the first end.

6. The coupling assembly of claim 5, wherein when the at least one spacer is in the first position, the first abutment side is spaced apart from the first end by a first distance such that the at least one base surface and at least one clamping surface are operable to provide a clamping action on a first solar photovoltaic module of the solar photovoltaic modules having a first side surface operatively engaged with the first abutment side.

7. The coupling assembly of claim 6, wherein when the at least one spacer is in the second position, the second abutment side is spaced apart from the second end by a second distance such that the at least one base surface and at least one clamping surface are operable to provide a clamping action on a second solar photovoltaic module of the solar photovoltaic modules having a second side surface operatively engaged with the second abutment side.

8. The coupling assembly of claim 7, wherein the first and second distances are the same.

9. The coupling assembly of claim 1, further comprising at least one electrical bonding component for providing a grounding path through the coupling assembly from at least one of the solar photovoltaic modules.

10. The coupling assembly of claim 9, wherein the at least one electrical bonding component is at least one of a bonding pin or a washer, electrical equipment bond.

11. The coupling assembly of claim 1, wherein the coupling assembly is adapted for mounting on a support assembly coupled to a roof of a building.

12. The coupling assembly of claim 1, wherein the coupling assembly is adapted to float above a roof of a building.

13. The coupling assembly of claim 1, wherein the base portion and cap portion are removably attachable to each other.

14. The coupling assembly of claim 1, wherein a width of the at least one spacer between the first and second abutment sides is between approximately ½ inch and approximately ¾ inch.

15. A coupling assembly for coupling a plurality of solar photovoltaic modules together in an array, the coupling assembly comprising:
a base portion including at least one base surface for operatively engaging a bottom surface of at least one of the solar photovoltaic modules;
a cap portion including at least one clamping surface located opposite the at least one base surface for operatively engaging a top surface of at least one of the solar photovoltaic modules, wherein at least one of the base surface or the clamping surface extends between first and second ends; and
at least one spacer variably positionable along one of the base portion or the cap portion and having first and second abutment sides each configured to operatively engage a side surface of at least one of the solar photovoltaic modules, the first and second abutment sides facing the first and second ends, respectively;
wherein the at least one base surface and the at least one clamping surface are moveable relative to each other such that movement of the at least one clamping surface toward the at least one base surface provides a clamping action on at least one of the solar photovoltaic modules positioned therebetween.

16. A method of coupling a plurality of solar photovoltaic modules together in an array with a coupling assembly including a base portion having at least one base surface, the coupling assembly further including a cap portion having at least one clamping surface, and at least one spacer variably positionable along one of the base portion or the cap portion and having first and second abutment sides, the method comprising:
positioning the base portion adjacent a first solar photovoltaic module such that the at least one base surface and the first abutment side operatively engage a first bottom surface and a first side surface of the first solar photovoltaic module, respectively;
positioning the base portion adjacent a second solar photovoltaic module such that the at least one base surface and the second abutment side operatively engage a second bottom surface and a second side surface of the second solar photovoltaic module, respectively;
positioning the cap portion over the base portion such that the at least one clamping surface operatively engages with first and second top surfaces of the first and second solar photovoltaic modules, respectively; and
moving the at least one clamping surface toward the at least one base surface to provide a clamping action on the first and second solar photovoltaic modules.

17. The method of claim 16, wherein at least one of the steps of positioning the base portion includes sliding the at least one spacer relative to the base portion or the cap portion.

18. The method of claim 16, further comprising:
mounting the coupling assembly on a support assembly coupled to a roof of a building.

19. The method of claim 16, further comprising:
floating the coupling assembly over a roof of a building.

20. A plurality of solar photovoltaic modules arranged in an array, comprising:
at least one coupling assembly of claim 1 for coupling at least two adjacent solar photovoltaic modules in the array.
